(19) United States
(12) Patent Application Publication
(10) Pub. No.: US 2026/0263984 A1
(43) Pub. Date: Sep. 10, 2026

(54) SYSTEM AND METHOD OF CO2 THERMAL SWING ADSORPTION WITH PROCESS IMPROVEMENTS

(71) Applicant: Enhanced Energy Group LLC, West Kingston, RI (US)

(72) Inventors: Garett Paul LAMBERT, Houston, TX (US); Barry Drake LAWSON, Houston, TX (US); Paul M. DUNN, West Kingston, RI (US); Behnam Fakhari KISOMI, Houston, TX (US)

(73) Assignee: Enhanced Energy Group LLC, West Kingston, RI (US)

(21) Appl. No.: 19/073,277

(22) Filed: Mar. 7, 2025

(51) Int. Cl. B01D 53/04; B01D 3/06; B01D 53/26; C01B 32/50; F25B 15/06

(52) U.S. Cl. CPC B01D 53/0462; B01D 3/06; B01D 53/26; C01B 32/50; F25B 15/06; B01D 2257/504; B01D 2257/80; B01D 2258/01

(57) ABSTRACT

A carbon capture system for carbon dioxide (CO₂) thermal swing adsorption (TSA) includes an engine configured to produce a hot exhaust stream; a CO₂ heat exchanger configured to cool a first portion of the hot exhaust stream as a result of a thermal exchange with a CO₂ stream to produce a first portion of a cooled exhaust stream; an absorption chiller configured to receive a second portion of the hot exhaust stream, and extract heat from the second portion of the hot exhaust stream to cool the second portion of the hot exhaust stream and produce a second portion of the cooled exhaust stream. An output of the CO₂ heat exchanger and an output of the absorption chiller are coupled such that the first portion of the cooled exhaust stream and the second portion of the cooled exhaust stream are combined to produce the cooled exhaust stream.

### TECHNICAL FIELD

The present disclosure relates generally to carbon capture and thermal swing adsorption (TSA) processes for carbon capture.

### BACKGROUND

Molecular (mole) sieves include synthetic media (e.g., ceramic-like media), available in various physical sizes (powder to ¼ inch round). Based on a composition and crystal structure of the synthetic media, mole sieves are capable of adsorbing, or not adsorbing, particular species of molecule based mostly on a size of the molecule. For example, a 3 A sieve will adsorb water (H₂O), ammonia (NH₃), and little else. Molecules like CO₂, O₂, N₂, and argon would pass through the 3 A sieve. The 3 A sieve (and alumina) are typically used in dehydration processes. A 5 A sieve will adsorb all of the species of the 3 A, but will also adsorb CO₂ and most pollutants (CO, HC, NOx) while allowing O₂, N₂, and argon to pass through the 5 A sieve. A 13× sieve captures larger molecules, including many hydrocarbons, but still allows O₂ and argon to pass through the 13× sieve. When a mole sieve is cold and a partial pressure of a desired species is high, the mole sieve will adsorb the desired species. The mole sieve will release the desired species when a temperature is increased and/or the partial pressure is lowered. Hence, the terms pressure swing, thermal swing, vacuum swing, or combinations of the swing processes are used to describe the capture and release of the desired species by the mole sieve. A viability and economics of carbon capture technologies are significantly impacted by an energy consumption of the CO₂ capture processes. However, the swing processes are inefficient in terms of electrical power required to perform the swing processes to sufficiently capture and release CO₂, which increases costs. In lieu of mole sieves, silica gels, activated carbons, and metal organic frameworks can be used for carbon capture purposes.

Activated carbon silica gels, and metal organic frameworks (MOFs) behave similarly to mole sieves, and can be used in lieu of mole sieves in some cases. However, activated carbon has a different affinity for compounds that is not based on molecule size. Using activated carbon is higher in cost and lower in performance in terms of CO₂ capture as compared with mole sieves, but has advantages of a lower heat of adsorption for water (e.g., about 1000 BTU/lb for activated carbon versus about 1800 BTU/lb for mole sieves) and a lower heat of adsorption for CO₂. MOFs can be utilized for carbon capture and also hold similar characteristics to mole sieves. MOFs do not have nearly as much affinity for water as traditional mole sieves and have the potential to be utilized for carbon capture. Currently, MOFs are being developed at a commercial scale and could serve as a replacement for molecular sieves in the future.

The carbon capture system of the present disclosure solves one or more of the problems set forth above and/or other problems in the field.

### SUMMARY

A carbon capture system for carbon dioxide (CO₂) thermal swing adsorption (TSA) may include an engine configured to produce a hot exhaust stream; a CO₂ heat exchanger configured to receive a first portion of the hot exhaust stream, and heat a CO₂ stream through a thermal exchange with the first portion of the hot exhaust stream to produce a heated CO₂ stream, wherein the first portion of the hot exhaust stream is cooled as a result of the thermal exchange to produce a first portion of a cooled exhaust stream; an absorption chiller configured to receive a second portion of the hot exhaust stream, and extract heat from the second portion of the hot exhaust stream to cool the second portion of the hot exhaust stream and produce a second portion of the cooled exhaust stream, wherein an output of the CO₂ heat exchanger and an output of the absorption chiller are coupled such that the first portion of the cooled exhaust stream and the second portion of the cooled exhaust stream are combined to produce the cooled exhaust stream; an adsorption inlet arranged downstream from the engine and configured to receive a cold exhaust stream comprising a mixture of CO₂ and nitrogen (N₂), wherein the cold exhaust stream is derived from the cooled exhaust stream; and a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust stream during the CO₂ capture stage.

A carbon capture system for CO₂ TSA may include an engine configured to produce a hot exhaust stream; a dehydration inlet arranged downstream from the engine and configured to receive a cold wet exhaust stream comprising a mixture of CO₂ and N₂, wherein the cold wet exhaust stream is derived from the hot exhaust stream using one or more thermal processes; a plurality of dehydration vessels that are configured to be respectively cycled through a plurality of dehydration stages, including a water capture stage, a dehydration regeneration stage, and a dehydration cooling stage, wherein the plurality of dehydration vessels are respectively coupled to the dehydration inlet for receiving the cold wet exhaust stream, wherein the cold wet exhaust stream is dehydrated during the water capture stage to produce a cold dry exhaust stream; an adsorption inlet arranged downstream from the plurality of dehydration vessels and configured to receive the cold dry exhaust stream; and a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold dry exhaust stream during the CO₂ capture stage, wherein a dehydration vessel, of the plurality of dehydration vessels, configured in the dehydration regeneration stage is configured to receive a gas stream from a capture vessel, of the plurality of capture vessels, configured in the cooling stage.

A carbon capture system for CO₂ TSA may include an engine configured to produce a hot exhaust stream; an adsorption inlet arranged downstream from the engine and configured to receive a cold exhaust stream comprising a mixture of CO₂ and N₂, wherein the cold exhaust stream is derived from the hot exhaust stream using one or more thermal processes; a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust stream during the CO₂ capture stage, wherein a capture vessel, of the plurality of capture vessels, configured in the CO₂ capture stage is configured to adsorb CO₂ from the cold exhaust stream to produce a first depleted flue gas, wherein a capture vessel, of the plurality of capture vessels, configured in the regeneration stage is configured to release captured CO₂ into a CO₂ stream, wherein a capture vessel, of the plurality of capture vessels, configured in the cooling stage is configured to receive a cooled gas such that capture media of the capture vessel configured in the cooling stage is cooled via the cooled gas, wherein the capture vessel configured in the cooling stage is configured to output a gas stream that has absorbed heat from the capture media of the capture vessel configured in the cooling stage; and a CO₂ processing system configured to receive a portion of the CO₂ stream from the capture vessel configured in the regeneration stage, wherein the CO₂ processing system includes: a CO₂ compressor configured to compress the CO₂ stream into a compressed CO₂ stream; a condenser heat exchanger configured to cool the compressed CO₂ stream via a thermal exchange with a chilled utility fluid to produce liquid CO₂; and a flash vessel configured to collect the liquid CO₂ and recycle a first portion of the liquid CO₂ back to the capture vessel configured in the regeneration stage.

### BRIEF DESCRIPTION OF THE DRAWINGS

FIG. 1A illustrates a first portion of a carbon capture system according to one or more implementations.

FIG. 1B illustrates a second portion of the carbon capture system shown in FIG. 1A.

FIG. 2 shows an example cycle timing diagram of a CO₂-TSA process using two dehydration vessels and three CO₂ capture vessels and a plurality of valves for a batch sequence.

FIG. 3 illustrates an absorption chiller according to one or more implementations.

### DETAILED DESCRIPTION

This disclosure relates to carbon capture, which is applicable to any machine, system, or plant that uses a combustion engine, such as a piston engine or a turbine engine. For example, the disclosure relates to a carbon capture system and a CO₂ thermal swing adsorption (TSA) process with improved performance using an absorption chiller coupled to an output of an exhaust source, such as the combustion engine.

Some implementations provide a system for a CO₂-TSA process with a minimum of three steps including adsorption (e.g., a capture stage), regeneration (e.g., a regeneration stage), and cooling (e.g., a cooling stage). For example, a CO₂-TSA process may include a cyclical sequence including at least a CO₂ capture stage (adsorption), a regeneration stage, and a cooling stage. A capture vessel may include capture media arranged inside the capture vessel configured to adsorb CO₂ from an exhaust gas during the CO₂ capture stage to produce a depleted flue gas, substantially depleted of CO₂, that exits the capture vessel. Additionally, or alternatively, a capture vessel may include capture media arranged inside the capture vessel configured to adsorb water molecules from an exhaust gas (e.g., from a wet gas) during a water capture stage to produce a dry gas that is substantially depleted of water molecules. Thus, a capture vessel may capture one or more adsorbates (e.g., CO₂, water molecules, or another component). The capture media for adsorbing CO₂ may be different from the capture media for adsorbing water molecules.

A capture medium's capacity for capturing an adsorbate, such as CO₂ or water, is higher at lower temperatures, and decreases with increasing temperature. Additionally, allowing the temperature of the capture medium to increase may cause the capture media to release a captured adsorbate. Moreover, when capture media are operated at lower capture efficiencies (e.g., due to higher capture media temperatures), more capture media are needed to capture a desired quantity of adsorbate, resulting in a need for higher quantities of capture media and larger capture vessels, which increases system costs. For example, lower carbon capture efficiencies lead to higher power consumption and higher operational costs. In view of these considerations, cooling the capture media prior to and/or during adsorption increases an adsorbate capture efficiency of the capture media, including increasing adsorbate capture capacity. Cooling the capture media prior to and/or during adsorption may also lead to smaller quantities of capture media and smaller carbon capture vessels being needed for adsorbate capture.

In some implementations, the absorption chiller is arranged upstream from carbon capture vessels that are configured to be respectively cycled through a plurality of stages of the CO₂-TSA process, including the CO₂ capture stage (adsorption), the regeneration stage, and the cooling stage. For example, the absorption chiller may be used to cool an exhaust stream produced by an exhaust source, such as the combustion engine. The cooling of the exhaust stream provided by the absorption chiller improves carbon capture efficiencies of the carbon capture vessels by maintaining lower temperatures at the carbon capture vessels during the CO₂ capture stage. Cooling the exhaust stream, from which CO₂ is to be captured, aids in maintaining lower capture media temperatures, and thus improves the carbon capture efficiencies of the carbon capture vessels. As a result, use of absorption chilling provided by an absorption chiller allows for a performance increase of capture media inside the carbon capture vessels. The capture media may include mole sieves, MOFs, activated carbons, or silica gels.

In some implementations, the absorption chiller utilizes hot exhaust provided by an engine to generate a chilled utility fluid. For example, the absorption chiller may use heat (e.g., waste heat) extracted from the exhaust stream to lower a temperature of a utility fluid to produce the chilled utility fluid. The chilled utility fluid may be used in heat exchangers (e.g., chiller heat exchangers) for chilling and condensation purposes. The chilling of the exhaust stream allows for a capacity increase of the capture media, which lowers system size requirements, thereby reducing system costs. Moreover, once CO₂ is captured in one of the carbon capture vessels, the captured CO₂ may be cooled, compressed, condensed via the chilled utility fluid, and pumped. Condensed CO₂ can either be flashed and/or distilled to remove oxygen and other impurities from the condensed CO₂. A total system size can be maintained with equal performance, or the total system size may be reduced, despite adding the absorption chiller as an additional component.

By chilling the exhaust stream provided to the carbon capture vessels, the absorption chiller may be used to improve an adsorption condition within each of the carbon capture vessels, resulting in substantial additional capacity within the capture media. Moreover, the chilled utility fluid produced by the absorption chiller may be used to further improve system efficiencies throughout the carbon capture system by including one or more chiller heat exchangers that use the chilled utility fluid to cool one or more target fluids within the carbon capture system. As a result, waste heat from the exhaust stream may be used as a heat source for producing the chilled utility fluid to further improve system efficiencies, reduce power consumption, and reduce system and operation costs. With a proper selection of the capture media, or media mix, to include MOF, mole sieves, activated carbon, alumina, and/or silica gels, and a cooling temperature achieved by the absorption chiller, optimum conditions for highest system performance can be achieved.

Temperature relative terms, such as “warm,” “hot,” “hotter,” “cold,” “colder,” “cool,” “cooler,” and the like, may be used herein for ease of description to describe one element or feature's relationship to another element(s) or feature(s) and are meant to be relative to each other and not restricted to any specific range of absolute temperature unless specifically defined. Even if specifically defined, absolute temperatures or temperature ranges are intended to serve as examples.

In some implementations, “dry,” “lean,” “wet,” and “rich” may be used herein for ease of description to describe one element or feature's relationship to another element(s) or feature(s) and are meant to be relative to each other and not restricted to any specific range of percent by volume. For example, “dry” may correspond to a gas or fluid that contains less water content than a wet gas or a wet fluid. Similarly, “lean” may correspond to a gas or fluid that contains less water content than a rich gas or a rich fluid. For example, in some implementations, a dry gas or a dry fluid may contain 50% less water than a corresponding wet gas or a corresponding wet fluid, respectively. In some implementations, a dry gas or a dry fluid may contain 75% less water than a corresponding wet gas or a corresponding wet fluid, respectively. In some implementations, a dry gas or a dry fluid may contain 90% less water than a corresponding wet gas or a corresponding wet fluid, respectively. In some implementations, a lean gas or a lean fluid may contain 50% less water than a corresponding rich gas or a corresponding rich fluid, respectively. In some implementations, a lean gas or a lean fluid may contain 75% less water than a corresponding rich gas or a corresponding rich fluid, respectively. In some implementations, a lean gas or a lean fluid may contain 90% less water than a corresponding rich gas or a corresponding rich fluid, respectively.

In some implementations, “dry” and “lean” may mean substantially free of water or water molecules. “Substantially free” may mean less than 1% by volume. Thus, “substantially free of water molecules” may refer to a fluid or a fluid mixture that is composed of less than 1% of water molecules by volume. In addition, “wet” or “rich” may mean saturated with or at least partially saturated with water or water molecules. For example, a fluid that is wet or rich may be composed of at least 1% of water molecules by volume. “Chiller” may refer to a device that chills, cools, or otherwise reduces a temperature of a target fluid. A heat exchanger that is used as a chiller (e.g., a chiller heat exchanger), may receive a refrigerant, a standard utility fluid, or a chilled utility fluid, and use the refrigerant, the standard utility fluid, or the chilled utility fluid to reduce the temperature of the target fluid by a thermal exchange. In contrast, “heater” may refer to a device that heats or otherwise increases a temperature of a target fluid. A heat exchanger that is used as a heater (e.g., a heater heat exchanger), may receive a hot utility fluid, and use the hot utility fluid to increase the temperature of the target fluid by a thermal exchange.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

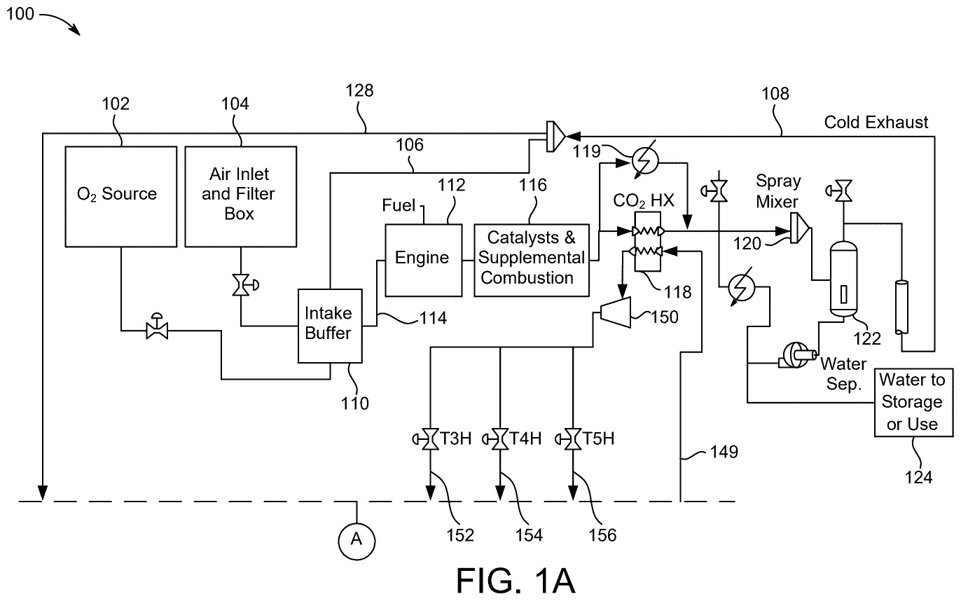

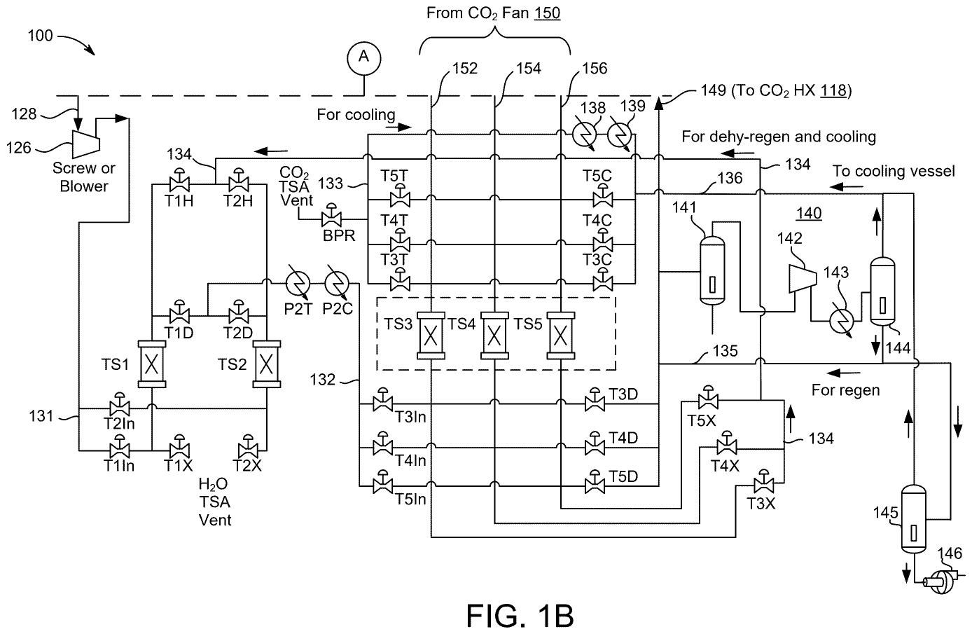

FIG. 1A illustrates a first portion of a carbon capture system 100 according to one or more implementations. FIG. 1B illustrates a second portion of the carbon capture system 100 shown in FIG. 1A. The first portion and the second portion are joined at dotted line A, such that certain manifolds extend across both FIGS. 1A and 1B.

The carbon capture system 100 includes components for a CO₂-TSA process with a semi-closed cycle (SCC). The components may be interconnected by a plurality of manifolds that may be configured to carry one or more fluids (e.g., liquids, gases, or gas-liquid mixtures).

The carbon capture system 100 may include an O₂ source 102 (e.g., an O₂ plant) that provides O₂, an air inlet and filter box 104 that provides air, an SCC path 106 that is used to provide a portion of cooled exhaust from an exhaust return path 108, an intake buffer tank 110, and an engine 112. As is the case with any combustion engine, fuel is combusted, and that combustion requires an oxidizer, which is generally air. The engine 112 (e.g., a turbine engine, piston engine) may draw in a working fluid 114 from the intake buffer tank 110. In some implementations, the engine 112 may be another type of exhaust source. The working fluid 114 used as an artificial atmosphere may be a mixture of air, oxygen, and cooled exhaust. A mixed concentration of oxygen in the intake buffer tank is variable, but generally falls in the range of 12-22% O₂. The engine 112 combusts the fuel in the artificial atmosphere to produce a hot exhaust (e.g., a hot flue gas). The hot exhaust may flow through optional catalysts and supplemental combustion (block 116) to a CO₂ heat exchanger (CO₂ HX) 118 (e.g., an exhaust heat exchanger)). The CO₂ heat exchanger 118 partially cools the hot exhaust (e.g., to about 400° F.) through a heat exchange with CO₂ gas released by a capture vessel (e.g., capture vessel TS3, TS4, or TS5) configured in a regeneration stage. For example, the hot exhaust coming from the engine 112 may be used in the CO₂ heat exchanger 118 to heat a CO₂ gas stream being recirculated from a regenerating capture vessel, thereby increasing a temperature of the CO₂ gas stream and decreasing a temperature of the hot exhaust via a heat exchange process.

In some examples, the CO₂ heat exchanger 118 receives a first portion of the hot exhaust stream, and heats the CO₂ gas stream through a thermal exchange with the first portion of the hot exhaust stream to produce a heated CO₂ stream. The first portion of the hot exhaust stream is cooled as a result of the thermal exchange with the CO₂ gas stream to produce a first portion of a cooled exhaust stream.

The carbon capture system 100 may include an absorption chiller 119 that receives a utility fluid and a second portion of the hot exhaust stream, extract heat from the second portion of the hot exhaust stream to cool the second portion of the hot exhaust stream and produce a second portion of the cooled exhaust stream, and use the heat extracted from the second portion of the hot exhaust stream to lower a temperature of the utility fluid to produce a chilled utility fluid.

The absorption chiller 119 may include a generator, a condenser, an evaporator, and an absorber. The generator may receive the second portion of the hot exhaust stream, and use the heat extracted from the second portion of the hot exhaust stream to evaporate water vapor from a refrigerant mixture. The condenser may condense the water vapor into condenser water by exposing the water vapor to cooler temperatures. The evaporator, at low pressure, may receive the utility fluid and the condenser water, cause the condenser water to cool based on the low pressure, and cool the utility fluid through a thermal exchange with the condenser water to produce the chilled utility fluid. The low pressure may be a vacuum pressure or a pressure near vacuum pressure. The absorber may mix the condenser water with a refrigerant to produce the refrigerant mixture, and provide the refrigerant mixture to the generator. The heat from the second portion of the hot exhaust stream is used in the generator to heat the refrigerant mixer to evaporate the water out of the refrigerant mixer. The evaporated water is then condensed by the condenser and recycled to the evaporator, which is cooled due to the low pressure in the evaporator and in turn is used to cool the utility fluid. The heat from the second portion of the hot exhaust stream from the exhaust is ultimately used to produce the chilled utility fluid. Thus, not only is heat extracted from the second portion of the hot exhaust stream to cool the hot exhaust stream, but the heat extracted from the second portion of the hot exhaust stream is used indirectly to cool the utility fluid to produce the chilled utility fluid. The carbon capture system 100 may include one or more chiller heat exchangers (e.g., heat exchangers P2C, 139, or 143) configured to receive the chilled utility fluid, and cool one or more target fluids via a respective thermal exchange with the chilled utility fluid.

An output of the CO₂ heat exchanger 118 and an output of the absorption chiller 119 are coupled such that the first portion of the cooled exhaust stream and the second portion of the cooled exhaust stream are combined to produce the cooled exhaust stream. In some implementations, the CO₂ heat exchanger 118 and the absorption chiller 119 are connected in parallel via manifolds configured to carry respective exhaust streams. Thus, the absorption chiller 119 outputs cooler exhaust back into a main exhaust stream. The cooler exhaust is used to lower a temperature of the main exhaust stream flow, which is also lowered by passing the main exhaust stream flow through CO₂ heat exchanger 118. The CO₂ heat exchanger 118 and an output of the absorption chiller 119 operate in parallel to lower an overall temperature of the main exhaust stream flow.

The cooled exhaust stream from the CO₂ heat exchanger 118 and the absorption chiller 119 is then mixed with colder water by a spray mixer 120, which quenches the partially cooled exhaust down to about 100° F. Additionally, or alternatively, a direct contact cooler (DCC) 122 may quench the cooled exhaust stream to lower a temperature of the cooled exhaust stream. As a result, most of the water from combustion products in the exhaust condenses, and the condensed water is removed in the DCC 122. The DCC 122 may be referred to as a gas-liquid separator. The condensed water accumulates in a water storage tank 124 unless the condensed water is otherwise used or disposed of. For example, the condensed water may be used as make-up water in a cooling tower, eliminating or reducing a problem of water disposal.

The cooled exhaust (e.g., cold exhaust), now depleted of most of the water, returns to the intake buffer tank 110 via the SCC path 106 or to a TSA screw/blower 126 (fan) via a TSA path 128. The SCC path 106 is part of an SCC exhaust loop that starts at the intake buffer tank 110, proceeds through the DCC 122 to the exhaust return path 108, and returns back through the SCC path to the intake buffer tank 110. The SCC is used to increase CO₂ concentration for an adsorption bed (e.g., for capture vessels TS3, TS4, and TS5) via exhaust recirculation. The increased CO₂ concentration provided by the SCC path 106 also increases a density of the gas mixture provided to the engine 112, which increases an output power of the engine 112.

A flowrate at the TSA screw/blower 126, which may be a variable speed drive or may include other methods of flow regulation, indirectly sets a level of exhaust recirculation, since an engine flowrate is essentially fixed. Thus, CO₂ that is not removed by the carbon capture system 100 may be recirculated, and a balance of the artificial atmosphere at the engine 112 will be made up by air and/or oxygen.

The TSA screw/blower 126 is used to draw a cold exhaust stream into a remaining portion of the carbon capture system 100 for carbon capture. The cold exhaust stream may be a wet exhaust stream as a result, in part, of the quenching performed by the spray mixer 120 and/or the DCC 122. Downstream of the TSA screw/blower 126 is a network of interconnected components that are responsible for performing the carbon capture via a CO₂-TSA process. Downstream of the TSA screw/blower 126 is a dehydration inlet 131 coupled to adsorbent vessels TS1 and TS2 (e.g., dehydration vessels). For example, the dehydration inlet 131 may be coupled to valves T1In and T2In, which control a flow of the cold exhaust to the adsorbent vessel TS1 and TS2 that is in a water adsorption stage.

Valves T1In, T2In, T1X, T2X, T1D, T2D, T1H, T2H, T3In, T4In, T5In, T3D, T4D, T5D, T3X, T4X, T5X, T3T, T4T, T5T, T3C, T4C, T5C, T3H, T4H, T5H, and BPR are used to control a flow of one or more fluids throughout the carbon capture system 100. An open state and a closed state of each of the valves may be controlled by a controller (not illustrated) according to one or more process stages of the CO₂-TSA process.

For example, three capture vessels TS3, TS4, or TS5 may be arranged in parallel, and the valves may be controlled such that a process stage at each one of the three capture vessels TS3, TS4, or TS5 (e.g., CO₂ capture vessels) is controlled based on a batch sequence of the CO₂-TSA process. For example, the valves may be controlled such that the capture vessel TS3 is in an adsorption stage (e.g., a capture stage), while the capture vessel TS4 is in a cooling stage and the capture vessel TS4 is in a regeneration stage. The valves may further be controlled such that the capture vessel TS4 is in an adsorption stage (e.g., a capture stage), while the capture vessel TSA5 is in a cooling stage and the capture vessel TSA3 is in a regeneration stage. The valves may further be controlled such that the capture vessel TS5 is in an adsorption stage (e.g., a capture stage), while the capture vessel TSA3 is in a cooling stage and the capture vessel TS4 is in a regeneration stage. The batch sequence may then be repeated. The cooling stage performed at the carbon capture vessels TS3, TS4, and TS5 may be referred to as a first cooling stage to distinguish this stage from a cooling stage (e.g., a second cooling stage) performed at the adsorbent vessels TS1 and TS2.

In some implementations, the capture vessels TS3, TS4, or TS5 may be referred to as “beds.” Each capture vessel TS3, TS4, and TS5 may include media (e.g., capture media) configured to capture or adsorb CO₂. In some cases, the media may also adsorb water.

A first step in the CO₂-TSA process is a water dehydration process carried out by a blend of alumina and a 3 A mole sieve in the adsorbent vessels TS1 and TS2. The water dehydration process is a batch type process. Thus, when one adsorbent vessel TS1 or TS2 is adsorbing water, the other adsorbent vessel TS1 or TS2 is off-line, either being heated (e.g., for regeneration) or being cooled. Adsorbent vessels TS1 and TS2 may be referred to as capture vessels, which are arranged in the carbon capture system 100 for capturing water molecules in the cold exhaust stream to produce a dry cold exhaust stream. Valves T1In and T2In control which adsorbent vessel TS1 or TS2 is receiving the cold exhaust from the TSA screw/blower 126.

In some implementations, a design point may be X hours for water adsorption (dehydration) in the adsorbent vessel TS1 and the adsorbent vessel TS2. In this example, the adsorbent vessel TS1 would be set for adsorbing water for X hours, and, in parallel, the adsorbent vessel TS2 would be first set for regeneration (heating) by opening valves T2H and T2X, for about Y hours, and then would be cooled, for about Z hours, with valves T2H and T2X still being open (where X=Y+Z). After X hours this process would reverse, with TS2 taking over the adsorption (dehydration) duty, and with TS1 being heated for regeneration and then cooled, via combinations of valve actions at T1H and T1X.

For description purposes, assuming that adsorbent vessel TS1 is dehydrating, valve T1In is open, and the cold exhaust stream flows through the adsorbent vessel TS1, out valve T1D, through heat exchanger P2T (e.g., a cooling tower), through another heat exchanger P2C (e.g., chiller), and to one of the capture vessels TS3, TS4, or TS5 for carbon capture. For example, an output of the heat exchanger P2C may be coupled to an adsorption inlet 132. The adsorption inlet 132 is arranged downstream from adsorbent vessels TS1 and TS2 (e.g., downstream from the engine 112, the dehydration inlet 131, and the adsorbent vessels TS1 and TS2) and configured to receive the dry cold exhaust stream comprising a mixture of CO₂ and nitrogen (N₂). The dry cold exhaust stream is derived from the cooled exhaust stream output from the CO₂ heat exchanger 118 and an output of the absorption chiller 119. The capture vessels TS3, TS4, or TS5 are respectively coupled to the adsorption inlet 132 for receiving the dry cold exhaust stream during the CO₂ capture stage.

Turning back to the water dehydration process, the adsorbent vessels TS1 and TS2 (e.g., dehydration vessels) are coupled downstream from the CO₂ heat exchanger 118 and upstream from the heat exchanger P2C. The heat exchanger P2C may be a first heat exchanger that uses the chilled utility fluid from the absorption chiller 119 to cool the exhaust stream to a lower temperature. In other words, the cold exhaust stream that flows through one of the adsorbent vessels TS1 or TS2 may be a target fluid of the one or more target fluids cooled by the chilled utility fluid from the absorption chiller 119, where the heat exchanger P2C uses the chilled utility fluid to further cool the cold exhaust stream for the capture vessels TS3, TS4, or TS5. The adsorbent vessels TS1 and TS2 are configured to be respectively cycled through a plurality of dehydration stages, including a water capture stage, a dehydration regeneration stage, and a dehydration cooling stage or a second cooling stage. The adsorbent vessels TS1 and TS2 are respectively coupled to a dehydration inlet 131 for receiving the cold (wet) exhaust stream, where the cold (wet) exhaust stream is dehydrated during the water capture stage.

In addition, outputs of the adsorbent vessels TS1 and TS2 are respectively coupled to the heat exchangers P2T and P2C during the water capture stage for providing the cold (dry) exhaust stream, dehydrated by the water capture stage, to the heat exchangers P2T and P2C. Heat exchanger P2T may cool the cold (dry) exhaust stream using a standard utility fluid, such as cold water provided by a cooling tower. Thus, the heat exchanger P2T may cause a temperature of the cold (dry) exhaust stream to decrease by a first amount (e.g., by a first temperature drop). Heat exchanger P2C may cool the cold (dry) exhaust stream using the chilled utility fluid. Thus, the heat exchanger P2C may cause a temperature of the cold (dry) exhaust stream to decrease by a second amount (e.g., by a second temperature drop).

The heat exchangers P2T and P2C are arranged in series, with the heat exchanger P2T being arranged first in the series, and the heat exchanger P2C being arranged second in the series. An order of the heat exchangers P2T and P2C is established to maximize cooling capabilities of the heat exchangers P2T and P2C, enabling a larger overall temperature drop than would otherwise be possible if the order was reversed. The heat exchanger P2C enables the cold (dry) exhaust stream to be cooled more than would otherwise be possible with the heat exchanger P2T alone.

A temperature of the chilled utility fluid is increased as a result of a thermal exchange with the cold (dry) exhaust stream, producing a warmer utility fluid. The warmer utility fluid is recycled back to the absorption chiller 119 for use as the utility fluid, which is subsequently chilled by the absorption chiller 119 to produce the chilled utility fluid. The chilling of the cold (dry) exhaust stream by the heat exchangers P2T and P2C allows for an increase in capture media performance of the capture vessels TS3, TS4, and TS5, and reduces an overall electrical load of the carbon capture system 100. For example, the chilling of the cold (dry) exhaust stream by the heat exchangers P2T and P2C may increase both a capture capacity and a capture efficiency of the capture vessels TS3, TS4, and TS5 during the CO₂ capture stage. The increase in capture media performance of the capture vessels TS3, TS4, and TS5 lowers the overall system cost, as sizes of the capture vessels TS3, TS4, and TS5 and other system equipment can be reduced, including a reduction in a quantity of capture media needed for carbon capture.

At the adsorption inlet 132 of the capture vessels TS3, TS4, and TS5, the cold (dry) exhaust has essentially zero water, and is typically composed of 3-11% CO₂ (by volume), 0-15% O₂ (by volume), and a balance inert mixture (e.g., nitrogen, with a little argon). By adsorbing water molecules, adsorbent vessels TS1 and TS2 convert a wet gas into a dry gas (or a drier gas) that may be substantially depleted of water molecules. The adsorbent vessels TS1 and TS2 may be cycled through adsorption (e.g., a capture stage), regeneration (e.g., a regeneration stage), and cooling (e.g., a cooling stage). During adsorption, water molecules are captured by the capture media. During regeneration, the capture media may be heated to desorb and release the water molecules from the capture media as a water vapor stream. During cooling, the capture media may be cooled in order to prepare the capture media for the next adsorption stage, where cooling increases a capture efficiency of the capture media. While one adsorbent vessel is in the water capture stage, the other adsorbent vessel is cycled through the dehydration regeneration stage and the dehydration cooling stage.

Assuming the capture vessel TS3 is at this point adsorbing CO₂, valve T3In will be open, with valves T4In and T5In closed. The exhaust gas, now depleted of CO₂ via the capture vessel TS3 and water via one of the adsorbent vessels TS1 and TS2, flows out of the capture vessel TS3 via valve T3T, which is open, while valves T4T and T5T are closed. The exhaust gas flowing out of the capture vessel TS3 (e.g., flowing out to adsorption outlet 133) is a relatively warm dry gas having a temperature around 80-160° F., and is composed mostly of N₂ gas, but may include other constituents. The exhaust gas flowing out of the capture vessel TS3 flows out of the capture vessel TS3 and through the valve T3T that is coupled to the adsorption outlet 133. The exhaust gas flowing out to the adsorption outlet 133 may be manifolded to one or more locations. For simplicity, this relatively warm dry gas that flows out of the capture vessel performing CO₂ adsorption (e.g., capture vessel TS3) may be referred to as a dry N₂ gas or a (dry) depleted flue gas that may be substantially depleted of CO₂.

If all downstream valves are closed, or if a backpressure for some reason is too high, any excess depleted flue gas will be discharged to atmosphere via a CO₂ TSA vent, controlled by a back pressure regulator of the valve BPR. Generally, the backpressure is lower than a setpoint of the back pressure regulator and the valve BPR remains closed.

Heat exchangers 138 and 139 are chiller heat exchanges that are coupled to the adsorption outlet 133 for receiving and cooling the depleted flue gas. The heat exchanger 139 may be a second heat exchanger that uses the chilled utility fluid from the absorption chiller 119. Assuming the capture vessel TS3 is adsorbing CO₂ (e.g., valves T3In and T3T are open), the depleted flue gas that exits the capture vessel TS3, via valve T3T, can be cooled via a heat exchanger 138 (e.g., a cooling tower) and heat exchanger 139 (e.g., chiller) arranged in series.

Heat exchanger 138 may cool the depleted flue gas using a standard utility fluid, such as cold water provided by a water tower. Thus, the heat exchanger 138 may cause a temperature of the depleted flue gas to decrease by a first amount (e.g., by a first temperature drop). Heat exchanger 139 may cool the depleted flue gas using the chilled utility fluid. Thus, the heat exchanger 139 may cause a temperature of the depleted flue gas to decrease by a second amount (e.g., by a second temperature drop).

The heat exchangers 138 and 139 are arranged in series with the heat exchanger 138 being arranged first in the sequence, and the heat exchanger 139 being arranged second in the sequence. An order of the heat exchangers 138 and 139 is established to maximize cooling capabilities of the heat exchangers 138 and 139, enabling a larger overall temperature drop than would otherwise be possible if the order was reversed. The heat exchanger 139 enables the depleted flue gas to be cooled more than would otherwise be possible with the heat exchanger 138 alone.

A capture vessel, of the capture vessels TS3, TS4, and TS5, configured in the CO₂ capture stage is configured to receive the cold exhaust stream from the adsorption inlet 132, and adsorb CO₂ from the cold exhaust stream to produce the depleted flue gas. The heat exchangers 138 and 139 receive the depleted flue gas from the capture vessel configured in the CO₂ capture stage, cool the depleted flue gas to produce a cooled depleted flue gas, and provide the cooled depleted flue gas to a capture vessel, of the capture vessels TS3, TS4, and TS5, configured in the cooling stage to cool the capture vessel and prepare the capture vessel for the CO₂ capture stage. Thus, the depleted flue gas is a target fluid to be cooled. The cooled depleted flue gas may be provided to the capture vessel configured in the cooling stage by opening one of valves T3C, T4C, or T5C.

A temperature of the chilled utility fluid is increased as a result of a thermal exchange with the depleted flue gas, producing a warmer utility fluid. The warmer utility fluid is recycled back to the absorption chiller 119 for use as the utility fluid, which is subsequently chilled by the absorption chiller 119 to produce the chilled utility fluid. The chilling of the depleted flue gas exhaust stream by the heat exchangers 138 and 139 allows for an increase in capture media performance of the capture vessels TS3, TS4, and TS5, and reduces an overall electrical load of the carbon capture system 100. The increase in capture media performance of the capture vessels TS3, TS4, and TS5 lowers the overall system cost, as sizes of the capture vessels TS3, TS4, and TS5 and other system equipment can be reduced.

The cooled depleted flue gas, used for cooling the capture vessel configured in the cooling stage, leaves the capture vessel and flows toward valves T3X, T4X, and T5X. For example, if capture vessel TS4 is in the cooling stage, the cooled depleted flue gas may pass through valve T4C to provide cooling to the capture vessel TS4, and may exit via valve T4X. The cooled depleted flue gas removes heat from the capture vessel configured in the cooling stage (e.g., TS4). The depleted flue gas that leaves the capture vessel configured in the cooling stage (e.g., TS4) may be directed along path 134 to one of the adsorbent vessels TS1 and TS2 (e.g., dehydration vessels) that is configured in the dehydration regeneration stage. The depleted flue gas that leaves the capture vessel configured in the cooling stage (e.g., TS4) may start out relatively warm and may become progressively cooler as the capture vessel configured in the cooling stage (e.g., TS4) becomes cooler. Thus, the depleted flue gas exiting the capture vessel TS4, set in the cooling stage, may be initially used to heat a regenerating adsorbent vessel TS1 or TS2, and then may be used to cool the cooling adsorbent vessel TS1 or TS2 as a temperature of the depleted flue gas exiting the capture vessel TS4 changes from relatively warm to relatively cool. Thus, the depleted flue gas that leaves the capture vessel configured in the cooling stage (e.g., TS4) may be directed along path 134 to one of the adsorbent vessels TS1 and TS2 (e.g., dehydration vessels) that is configured in the dehydration cooling stage, which is the same adsorbent vessel TS1 or TS2 that was just configured in the dehydration regeneration stage.

In other words, the adsorbent vessel TS1 or TS2, configured in the dehydration regeneration stage and subsequently configured in the dehydration cooling stage, may receive a gas stream from path 134 (e.g., from the capture vessel TS4 configured in the cooling stage). The gas stream may initially heat the adsorbent vessel TS1 or TS2 configured in the dehydration regeneration stage to remove water from the adsorbent vessel TS1 or TS2, and may subsequently cool the adsorbent vessel TS1 or TS2 configured in the dehydration cooling stage. The gas stream from path 134 may be vented to atmosphere via valve T1X or valve T2X after the adsorbent vessel TS1 or TS2 has been regenerated and cooled. Meanwhile, the other adsorbent vessel TS2 or TS1 is in the water capture stage, as described elsewhere herein.

Based on using the gas stream from path 134 for dehydration regeneration and dehydration cooling stages, heat stored in a capture vessel (e.g., TS4) at the end of capture regeneration is moved via the cooling process to a regenerating adsorbent vessel TS1 or TS2. A product of a mass and specific heat of the capture media of a capture vessel T3X, T4X, or T5X is much greater than that of the dehydration capture media of an adsorbent vessel TS1 or TS2. As a result, it is possible to use the depleted flue gas exiting a cooling capture vessel (e.g., TS4) to fully heat and drive out water from the regenerating adsorbent vessel TS1 or TS2 for regeneration without requiring an additional heater.

After the CO₂ adsorption cycle is complete (e.g., in capture vessel TS3), the captured CO₂ must be released during the regeneration stage. In a TSA process, releasing captured CO₂ is done mostly via heating the capture media of the capture vessel. In the present disclosure, that heating is provided by a hot gas mixture, which is mostly hot CO₂ gas in this example delivered via valve T3H to the capture vessel TS3. The hot CO₂ gas is generally at 600-800° F. The hot CO₂ gas flows as a hot CO₂ stream downward from a CO₂ fan 150, through valve T3H, and through the media in the capture vessel TS3, which gradually heats the media, and drives off more CO₂. Warm CO₂ exits the capture vessel TS3 as a CO₂ stream and flows via valve T3D to manifold 149, where at least a portion of the CO₂ stream is directed to the CO₂ heat exchanger 118. The CO₂ stream entering the CO₂ heat exchanger 118 is heated by the hot exhaust stream produced by the engine 112 by a thermal exchange. The thermal exchange causes a temperature of the CO₂ stream to increase, thereby producing the hot CO₂ stream that flows downstream through the CO₂ fan 150. The thermal exchange also causes a temperature of the hot exhaust stream to decrease, thereby producing the first portion of the cooled exhaust stream that is output from the CO₂ heat exchanger 118.

The CO₂ fan 150 is arranged downstream from the CO₂ heat exchanger 118 such that the CO₂ fan 150 is coupled between the CO₂ heat exchanger 118 and the capture vessels TS3, TS4, and TS5. A placement of CO₂ fan 150 downstream from the CO₂ heat exchanger 118 causes a constant temperature to enter the CO₂ fan 150. As a result, cost of the CO₂ fan 150 can be reduced, in addition to elevating a temperature of a regenerating capture vessel to improve regeneration performance. The CO₂ heat exchanger 118 is configured to receive the CO₂ stream from a capture vessel, of the capture vessels TS3, TS4, and TS5, configured in the regeneration stage, and provide the heated CO₂ stream to the capture vessel configured in the regeneration stage from which the CO₂ stream was received. The CO₂ fan 150 is configured to direct the CO₂ stream from the capture vessel configured in the regeneration stage to the CO₂ heat exchanger 118, and direct the heated CO₂ stream from the CO₂ heat exchanger 118 to the capture vessel configured in the regeneration stage to drive out captured CO₂. The CO₂ fan 150 drives a CO₂ product throughout the carbon capture system 100 and removes heat from the exhaust stream via CO₂ heat exchanger 118.

Accordingly, heat used to heat a capture vessel TS3, TS4, or TS5 during the regeneration stage comes from the exhaust of the engine 112. In an example in which the capture vessel TS3 is in the regeneration stage, after passing through valve T3D, a portion of the CO₂ gas released from the relevant capture vessel TS3, TS4, or TS5 (e.g., capture vessel TS3 in this example,) enters the CO₂ heat exchanger 118 via manifold 149. In other words, the manifold 149 connects capture vessel TS3, TS4, and TS5 to the CO₂ heat exchanger 118 to transport a CO₂ stream of CO₂ gas generated by a capture vessel set in the regeneration stage to the CO₂ heat exchanger 118.

The CO₂ gas enters the CO₂ heat exchanger 118, and is heated to near raw exhaust temperature, typically 800-900° F., by a heat exchange process that uses the exhaust from the engine 112 for heating the heated CO₂ gas to produce hot CO₂ gas. This hot CO₂ gas is then passed through the CO₂ fan 150, which is responsible for drawing the CO₂ gas into the CO₂ heat exchanger 118 and pushing the hot CO₂ gas through the capture vessel TS3, TS4, or TS5 that is performing a regeneration (e.g., capture vessel TS3 in this example). Thus, the CO₂ fan 150 recirculates the CO₂ gas exiting the capture vessel TS3, TS4, or TS5 that is performing the regeneration through the CO₂ heat exchanger 118 and returns the CO₂ gas back to the capture vessel TS3, TS4, or TS5 that is performing the regeneration as the hot CO₂ gas. The hot CO₂ gas may cause a temperature of the capture vessel TS3, TS4, or TS5 that is performing the regeneration to increase, which causes more CO₂ to be released from the capture vessel and enhances regeneration. The CO₂ fan 150 may be respectively coupled to the capture vessels TS3, TS4, TS5 via manifolds 152, 154, and 156 to provide a heated CO₂ gas to a capture vessel that is set in the regeneration stage. At an end of the regeneration process, virtually no CO₂, and almost no water, remains in the capture vessel TS3, TS4, or TS5 that is performing the regeneration (e.g., the capture vessel TS3).

As a result of the regeneration process, the capture media of the capture vessel TS3, TS4, or TS5 are hot, typically with an average temperature of about 500° F., and must be cooled to prepare the capture vessel for a next CO₂ adsorption cycle. A cooling process for the capture vessel TS3 is accomplished by opening valves T3C and T3X, while closing valves T3In, T3T, T3H, and T3D. In other words, the dry (warm) N₂ gas that exits the capture vessel set in the adsorbing stage (e.g., capture vessel TS5 for cooling of capture vessel TS3) is directed into the capture vessel TS3 for cooling the media of the capture vessel TS3.

The cooling process need not return the media temperature fully to ambient temperature. Any temperature under 100° C. (212° F.) will provide some capacity for initial adsorption of CO₂, with temperatures near or below 10° C. (122° F.) being preferred. The cooling process may continue in parallel with the adsorption process to some extent since a raw exhaust stream from heat exchangers P2T and P2C (e.g., chillers) is provided at 0-10° C. (32-50° F.).

In some implementations, a portion of the CO₂ gas may split off from manifold 149 and flow into a CO₂ processing system 140. The CO₂ processing system 140 may include a vessel 141, a CO₂ compressor 142, a condenser heat exchanger 143 (e.g., a chiller), a flash vessel 144, a distillation column 145, and a pump 146. The CO₂ processing system 140 receives a portion of the CO₂ stream from the capture vessel configured in the regeneration stage (e.g., capture vessel TS3, TS4, or TS5).

The vessel 141 may collect a volume of CO₂ in order to improve control of a CO₂ flow through the CO₂ processing system 140. The CO₂ compressor 142 may compress the CO₂ stream into a compressed CO₂ stream. A flowrate at the CO₂ compressor 142, also generally a variable speed, may indirectly set a pressure in the capture vessel TS3, TS4, or TS5 during a desorption process of the regeneration stage. The condenser heat exchanger 143 may cool the compressed CO₂ stream via a thermal exchange with the chilled utility fluid to produce liquid CO₂. Thus, the compressed CO₂ stream may be a target fluid of the one or more target fluids. Thus, the condenser heat exchanger 143 uses the chilled utility fluid from the absorption chiller 119 to cool and condense the CO₂ stream. A temperature of the chilled utility fluid is increased as a result of a thermal exchange with the CO₂ stream, producing a warmer utility fluid. The warmer utility fluid may be recycled back to the absorption chiller 119 for use as the utility fluid, which is subsequently chilled by the absorption chiller 119 to produce the chilled utility fluid.

The flash vessel 144 may collect the liquid CO₂ and recycle a first portion of the liquid CO₂ back to the capture vessel configured in the regeneration stage (e.g., a regeneration vessel, such as capture vessel TS3, TS4, or TS5). For example, path 135 may provide the first portion of the liquid CO₂ to manifold 149, which is then directed toward the CO₂ heat exchanger 118 and CO₂ fan 150 to a regenerating capture vessel.

The flash vessel 144 may also convert a second portion of the liquid CO₂ into CO₂ vapor (e.g., by flashing). Thus, the flash vessel 144 is a lower pressure vessel capable of flashing liquid product into vapor. The flash vessel 144 may provide the CO₂ vapor to path 136 connected to the capture vessel configured in the cooling stage (e.g., capture vessel TS3, TS4, or TS5) for capturing CO₂ from the CO₂ vapor by the capture vessel configured in the cooling stage. The flash vessel 144 may remove non-condensable components from the second portion of the liquid CO₂ through flash separation.

The flash vessel 144 may also collect the liquid CO₂ and recycle a third portion of the liquid CO₂ to the distillation column 145 for removal of impurities from the third portion of the liquid CO₂ to produce purified CO₂. The purified CO₂ may be pumped out by the pump 146 for collection and storage. For example, the purified CO₂ may be used in one or more consumer products (e.g., food grade consumer products), for enhanced oil recovery (EOR), and/or sequestration. The distillation column 145 may convert a portion of the liquid CO₂ (e.g., a fourth portion of liquid CO₂) received from the flash vessel 144 into additional CO₂ vapor, and provide the additional CO₂ vapor to path 136 connected to the capture vessel configured in the cooling stage (e.g., capture vessel TS3, TS4, or TS5) by the appropriate valves. The capture vessel configured in the cooling stage may capture CO₂ from the CO₂ vapor.

In some implementations, the third portion of the liquid CO₂ may be pumped to a final delivery pressure that lowers power requirements when compared to compression power. The final delivery pressure can be a required pipeline pressure or another required pressure dependent on application or use.

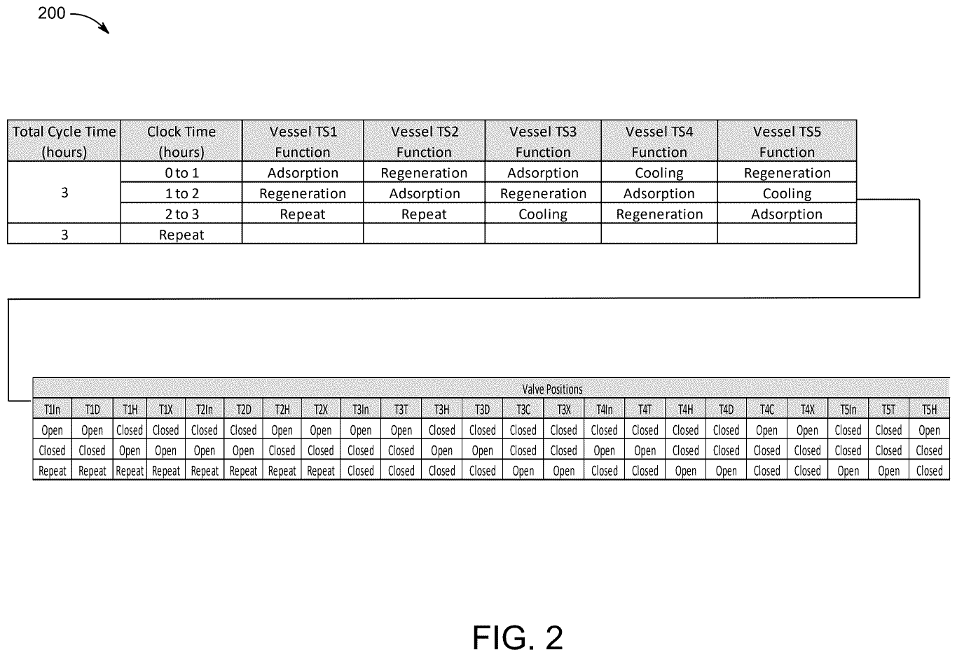

FIG. 2 shows an example cycle timing diagram 200 of the CO₂-TSA process using capture vessels TS3, TS4, and TS5, including a state of each of the valves during each stage, including the adsorption stage, the cooling stage, and the regeneration stage of the batch sequence.

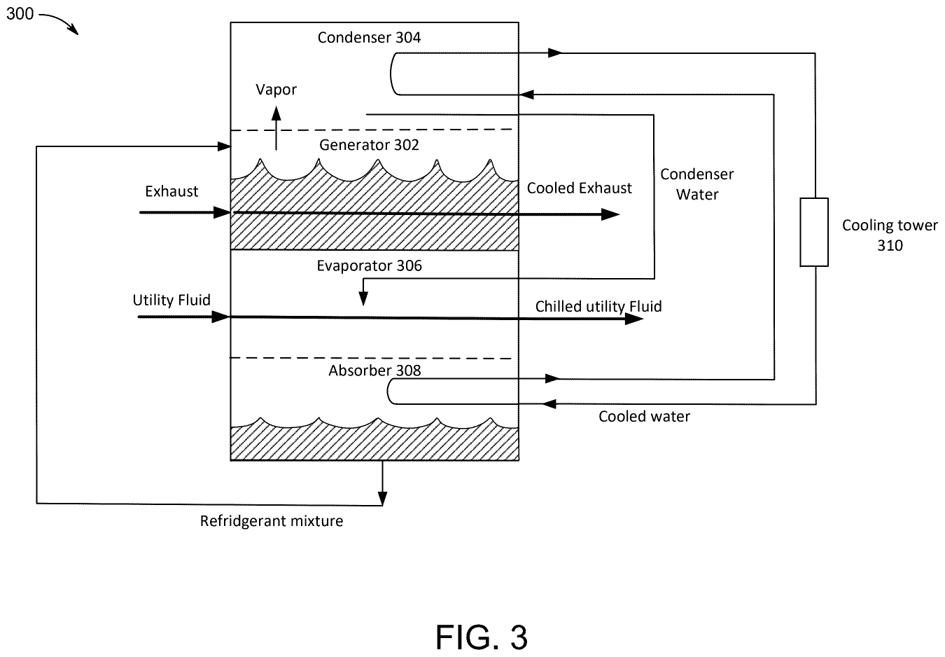

FIG. 3 shows an absorption chiller 300 according to one or more implementations. The absorption chiller 300 may be similar to absorption chiller 119 described in connection with FIGS. 1A and 1B. The absorption chiller 300 may include a generator 302, a condenser 304, an evaporator 306, and an absorber 308.

The generator 302 may receive a refrigerant mixture from the absorber 308. In addition, the generator 302 may receive a hot exhaust stream from an exhaust source, such as engine 112 described in connection with FIGS. 1A and 1B. For example, the hot exhaust stream may be the second portion of the hot exhaust stream. In some implementations, the generator 302 may receive waste heat from another waste heat source. The generator 302 may use heat extracted from the second portion of the hot exhaust stream (or waste heat from another waste heat source) to evaporate water vapor from a refrigerant mixture. As a result of the heat from the hot exhaust stream being used to produce the water vapor, the hot exhaust stream loses heat and is cooled into cooled exhaust. The cooled exhaust exits the generator 302. The cooled exhaust may correspond to the second portion of the cooled exhaust stream described in connection with FIGS. 1A and 1B. The hot exhaust stream and the cooled exhaust may be contained within a pipe that is fed into and out of the generator 302.

The condenser 304 may condense the water vapor into condenser water by exposing the water vapor to cooler temperatures. For example, the water vapor may condense into liquid as the water vapor comes into contact with a cooling coil of the condenser 304. Water within the cooling coil may be provided by a cooling tower 310.

The evaporator 306 may receive a utility fluid and the condenser water through appropriate piping. The evaporator 306 may be a low-pressure chamber that causes the condenser water to cool based on a low pressure, and cool the utility fluid through a thermal exchange with the condenser water to produce the chilled utility fluid. The low pressure may be a vacuum pressure or at a pressure near vacuum pressure. The utility fluid and the chilled utility fluid may be contained within a pipe that is fed into and out of the evaporator 306.

The absorber 308 may mix the condenser water with a refrigerant, such as lithium bromide, to produce the refrigerant mixture, and provide the refrigerant mixture to the generator 302. A cooling tower water loop may also pass through the absorber 308 to carry away unwanted heat.

### INDUSTRIAL APPLICABILITY

The described implementations significantly reduce the carbon footprint of gas turbine and piston engine operations as a result of achieving a high CO₂ capture percentage, generally greater than 95%, with the combination of techniques disclosed herein.

Advanced capture system designs disclosed herein may improve capture media performance via enhanced cooling and fluid flow management. In addition, the advanced capture system designs disclosed herein may result in more efficient carbon capture processes, including a higher percentage of CO₂ capture. In addition, the advanced capture system designs disclosed herein may result in more efficient water capture processes, including a higher percentage of water capture in dehydration vessels and more effective dehydration regeneration and cooling stages. In addition, the advanced capture system designs disclosed herein may use waste heat from one or more gas flows to improve one or more aspects of carbon capture and/or dehydration, including regeneration stages for both carbon capture vessels and dehydration vessels. In addition, the advanced capture system designs disclosed herein may result in a reduction in system costs, including a reduction in an amount of capture media needed to achieve a desired CO₂ capture percentage, which results in smaller capture vessels and other equipment, such as fans. In some implementations, heaters that may otherwise be required in conventional systems may be eliminated, further helping to reduce system costs and operation costs. In addition, the advanced capture system designs disclosed herein may result in a reduction in operation costs, including a reduction in electrical power required to achieve a desired CO₂ capture percentage. The advanced capture system designs disclosed herein may contribute to higher overall system efficiencies that make carbon capture more efficient and more economical.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A carbon capture system for carbon dioxide (CO₂) thermal swing adsorption (TSA), the carbon capture system comprising:
an engine configured to produce a hot exhaust stream;
a CO₂ heat exchanger configured to receive a first portion of the hot exhaust stream, and heat a CO₂ stream through a thermal exchange with the first portion of the hot exhaust stream to produce a heated CO₂ stream, wherein the first portion of the hot exhaust stream is cooled as a result of the thermal exchange to produce a first portion of a cooled exhaust stream;
an absorption chiller configured to receive a second portion of the hot exhaust stream, and extract heat from the second portion of the hot exhaust stream to cool the second portion of the hot exhaust stream and produce a second portion of the cooled exhaust stream,
wherein an output of the CO₂ heat exchanger and an output of the absorption chiller are coupled such that the first portion of the cooled exhaust stream and the second portion of the cooled exhaust stream are combined to produce the cooled exhaust stream;
an adsorption inlet arranged downstream from the engine and configured to receive a cold exhaust stream comprising a mixture of CO₂ and nitrogen (N₂), wherein the cold exhaust stream is derived from the cooled exhaust stream; and
a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust stream during the CO₂ capture stage.

2. The carbon capture system of claim 1, wherein the CO₂ heat exchanger and the absorption chiller are connected in parallel via manifolds configured to carry respective exhaust streams.

3. The carbon capture system of claim 1, wherein the absorption chiller is configured to receive a utility fluid, and use the heat extracted from the second portion of the hot exhaust stream to lower a temperature of the utility fluid to produce a chilled utility fluid,
wherein the absorption chiller comprises:
a generator configured to receive the second portion of the hot exhaust stream, and use the heat extracted from the second portion of the hot exhaust stream to evaporate water vapor from a refrigerant mixture;
a condenser configured to condense the water vapor into condenser water;
an evaporator, at low pressure, configured to receive the utility fluid and the condenser water, cause the condenser water to cool based on the low pressure, and cool the utility fluid through a thermal exchange with the condenser water to produce the chilled utility fluid; and
an absorber configured to mix the condenser water with a refrigerant to produce the refrigerant mixture, and provide the refrigerant mixture to the generator.

4. The carbon capture system of claim 1, further comprising:
a CO₂ fan coupled to the CO₂ heat exchanger and to the plurality of capture vessels,
wherein the CO₂ heat exchanger is configured to receive the CO₂ stream from a capture vessel, of the plurality of capture vessels, configured in the regeneration stage, and provide the heated CO₂ stream to the capture vessel configured in the regeneration stage from which the CO₂ stream was received,
wherein the CO₂ fan is configured to direct the CO₂ stream from the capture vessel configured in the regeneration stage to the CO₂ heat exchanger, and direct the heated CO₂ stream from the CO₂ heat exchanger to the capture vessel configured in the regeneration stage, and
wherein the CO2 fan is arranged downstream from the CO₂ heat exchanger.

5. The carbon capture system of claim 1, wherein the absorption chiller is configured to receive a utility fluid, and use the heat extracted from the second portion of the hot exhaust stream to lower a temperature of the utility fluid to produce a chilled utility fluid,
wherein the carbon capture system includes one or more chiller heat exchangers configured to receive the chilled utility fluid, and cool one or more target fluids via a respective thermal exchange with the chilled utility fluid,
wherein the one or more chiller heat exchangers include a first heat exchanger coupled to the adsorption inlet,
wherein the first heat exchanger is configured to cool the cold exhaust stream to a lower temperature, and provide the cold exhaust stream with the lower temperature to the adsorption inlet, and
wherein the cold exhaust stream is a target fluid of the one or more target fluids.

6. The carbon capture system of claim 5, further comprising:
a plurality of dehydration vessels coupled downstream from the CO₂ heat exchanger and upstream from the first heat exchanger,
wherein the plurality of dehydration vessels are configured to be respectively cycled through a plurality of dehydration stages, including a water capture stage, a dehydration regeneration stage, and a second cooling stage,
wherein the plurality of dehydration vessels are respectively coupled to a dehydration inlet for receiving the cold exhaust stream, wherein the cold exhaust stream is dehydrated during the water capture stage, and
wherein the plurality of dehydration vessels are respectively coupled to the first heat exchanger during the water capture stage for providing the cold exhaust stream, dehydrated by the water capture stage, to the first heat exchanger.

7. The carbon capture system of claim 6, wherein a dehydration vessel, of the plurality of dehydration vessels, configured in the dehydration regeneration stage is configured to receive a gas stream from a capture vessel, of the plurality of capture vessels, configured in the cooling stage, and
wherein the gas stream is configured to heat the dehydration vessel configured in the dehydration regeneration stage to remove water from the dehydration vessel configured in the dehydration regeneration stage, and subsequently cool a dehydration vessel configured in the second cooling stage.

8. The carbon capture system of claim 1, wherein the absorption chiller is configured to receive a utility fluid, and use the heat extracted from the second portion of the hot exhaust stream to lower a temperature of the utility fluid to produce a chilled utility fluid,
wherein the carbon capture system includes one or more chiller heat exchangers configured to receive the chilled utility fluid, and cool one or more target fluids via a respective thermal exchange with the chilled utility fluid,
wherein the one or more chiller heat exchangers include a second heat exchanger coupled to an adsorption outlet of the plurality of capture vessels,
wherein a capture vessel, of the plurality of capture vessels, configured in the CO₂ capture stage is configured to receive the cold exhaust stream and adsorb CO₂ from the cold exhaust stream to produce a depleted flue gas,
wherein the second heat exchanger is configured to receive the depleted flue gas from the capture vessel configured in the CO₂ capture stage, cool the depleted flue gas to produce a cooled gas, and provide the cooled gas to a capture vessel, of the plurality of capture vessels, configured in the cooling stage, and
wherein the depleted flue gas is a target fluid of the one or more target fluids.

9. The carbon capture system of claim 1, further comprising:
a CO₂ processing system configured to receive a portion of the CO₂ stream from a capture vessel, of the plurality of capture vessels, configured in the regeneration stage, wherein the CO₂ processing system includes:
a CO₂ compressor configured to compress the CO₂ stream into a compressed CO₂ stream;
a condenser heat exchanger configured to cool the compressed CO₂ stream via a thermal exchange with a chilled utility fluid to produce liquid CO₂; and
a flash vessel configured to collect the liquid CO₂ and recycle a first portion of the liquid CO₂ back to the capture vessel configured in the regeneration stage,
wherein the absorption chiller is configured to receive a utility fluid, and use the heat extracted from the second portion of the hot exhaust stream to lower a temperature of the utility fluid to produce the chilled utility fluid.

10. The carbon capture system of claim 9, wherein the flash vessel is configured to convert a second portion of the liquid CO₂ into CO₂ vapor, and provide the CO₂ vapor to a capture vessel, of the plurality of capture vessels, configured in the cooling stage for capturing CO₂ from the CO₂ vapor,
wherein the flash vessel is configured to remove non-condensable components from the second portion of the liquid CO₂ through flash separation.

11. The carbon capture system of claim 1, further comprising:
a CO₂ processing system configured to receive a portion of the CO₂ stream from a capture vessel, of the plurality of capture vessels, configured in the regeneration stage, wherein the CO₂ processing system includes:
a distillation column;
a CO₂ compressor configured to compress the CO₂ stream into a compressed CO₂ stream;
a condenser heat exchanger configured to cool the compressed CO₂ stream via a respective thermal exchange with a chilled utility fluid to produce liquid CO₂; and
a flash vessel configured to collect the liquid CO₂ and provide a first portion of the liquid CO₂ to the distillation column for removal of impurities from the first portion of the liquid CO₂,
wherein the absorption chiller is configured to receive a utility fluid, and use the heat extracted from the second portion of the hot exhaust stream to lower a temperature of the utility fluid to produce the chilled utility fluid.

12. The carbon capture system of claim 11, wherein the flash vessel is configured to convert a second portion of the liquid CO₂ into CO₂ vapor, and provide the CO₂ vapor to a capture vessel, of the plurality of capture vessels, configured in the cooling stage for capturing CO₂ from the CO₂ vapor.

13. The carbon capture system of claim 12, wherein the distillation column is configured to convert a third portion of the liquid CO₂ into additional CO₂ vapor, and provide the additional CO₂ vapor to the capture vessel configured in the cooling stage for cooling the capture vessel configured in the cooling stage.

14. A carbon capture system for carbon dioxide (CO2) thermal swing adsorption (TSA), the carbon capture system comprising:
an engine configured to produce a hot exhaust stream;
a dehydration inlet arranged downstream from the engine and configured to receive a cold wet exhaust stream comprising a mixture of CO₂ and nitrogen (N₂), wherein the cold wet exhaust stream is derived from the hot exhaust stream using one or more thermal processes;
a plurality of dehydration vessels that are configured to be respectively cycled through a plurality of dehydration stages, including a water capture stage, a dehydration regeneration stage, and a dehydration cooling stage, wherein the plurality of dehydration vessels are respectively coupled to the dehydration inlet for receiving the cold wet exhaust stream, wherein the cold wet exhaust stream is dehydrated during the water capture stage to produce a cold dry exhaust stream;
an adsorption inlet arranged downstream from the plurality of dehydration vessels and configured to receive the cold dry exhaust stream; and
a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold dry exhaust stream during the CO₂ capture stage,
wherein a dehydration vessel, of the plurality of dehydration vessels, configured in the dehydration regeneration stage is configured to receive a gas stream from a capture vessel, of the plurality of capture vessels, configured in the cooling stage.

15. The carbon capture system of claim 14, wherein the gas stream is configured to heat the dehydration vessel configured in the dehydration regeneration stage to remove water from the dehydration vessel configured in the dehydration regeneration stage.

16. A carbon capture system for carbon dioxide (CO₂) thermal swing adsorption (TSA), the carbon capture system comprising:
an engine configured to produce a hot exhaust stream;
an adsorption inlet arranged downstream from the engine and configured to receive a cold exhaust stream comprising a mixture of CO₂ and nitrogen (N₂), wherein the cold exhaust stream is derived from the hot exhaust stream using one or more thermal processes;
a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust stream during the CO₂ capture stage,
wherein a capture vessel, of the plurality of capture vessels, configured in the CO₂ capture stage is configured to adsorb CO₂ from the cold exhaust stream to produce a first depleted flue gas,
wherein a capture vessel, of the plurality of capture vessels, configured in the regeneration stage is configured to release captured CO₂ into a CO₂ stream,
wherein a capture vessel, of the plurality of capture vessels, configured in the cooling stage is configured to receive a cooled gas such that capture media of the capture vessel configured in the cooling stage is cooled via the cooled gas,
wherein the capture vessel configured in the cooling stage is configured to output a gas stream that has absorbed heat from the capture media of the capture vessel configured in the cooling stage; and
a CO₂ processing system configured to receive a portion of the CO₂ stream from the capture vessel configured in the regeneration stage,
wherein the CO₂ processing system includes:
a CO₂ compressor configured to compress the CO₂ stream into a compressed CO₂ stream;
a condenser heat exchanger configured to cool the compressed CO₂ stream via a thermal exchange with a chilled utility fluid to produce liquid CO₂; and
a flash vessel configured to collect the liquid CO₂ and recycle a first portion of the liquid CO₂ back to the capture vessel configured in the regeneration stage.

17. The carbon capture system of claim 16, wherein the flash vessel is configured to convert a second portion of the liquid CO₂ into CO₂ vapor, and provide the CO₂ vapor to the capture vessel configured in the cooling stage for cooling the capture media of the capture vessel configured in the cooling stage.

18. The carbon capture system of claim 16, wherein the CO₂ processing system further includes a distillation column, and
wherein the flash vessel is configured to provide a third portion of the liquid CO2 to the distillation column for removal of impurities from the third portion of the liquid CO2.

19. The carbon capture system of claim 18, wherein the distillation column is configured to convert a fourth portion of the liquid CO₂ into additional CO₂ vapor, and provide the additional CO₂ vapor to the capture vessel configured in the cooling stage for cooling the capture media of the capture vessel configured in the cooling stage.

20. The carbon capture system of claim 16, further comprising:
an absorption chiller configured to receive a utility fluid and a portion of the hot exhaust stream, extract heat from the portion of the hot exhaust stream to cool the portion of the hot exhaust stream and produce a cooled exhaust stream, and use the heat extracted from the portion of the hot exhaust stream to lower a temperature of the utility fluid to produce the chilled utility fluid,
wherein the carbon capture system is configured to use the cooled exhaust stream to produce the cold exhaust stream.
